(19) United States
(12) Patent Application Publication
(10) Pub. No.: US 2015/0089122 A1
(43) Pub. Date: Mar. 26, 2015

(54) APPARATUS, CONTROL APPARATUS, CONTROL METHOD AND STORAGE MEDIUM

(71) Applicant: CANON KABUSHIKI KAISHA, Tokyo (JP)

(72) Inventor: Naoki Oyama, Yokohama-shi (JP)

(21) Appl. No.: 14/489,845

(22) Filed: Sep. 18, 2014

(30) Foreign Application Priority Data
Sep. 26, 2013 (JP) 2013-200521

(51) Int. Cl. G06F 12/02

(52) U.S. Cl. CPC G06F 12/0246; G06F 2212/7211
USPC 711/103

(57) ABSTRACT

An apparatus, when a storage unit is initialized, writes dummy data to an area of the storage unit, and when actual data is written to the storage unit, releases the dummy data written in the area of the storage unit, and writes the actual data in the released area, and also when the actual data is deleted from the storage unit, writes dummy data to an area in which the actual data is written.

### BACKGROUND OF THE INVENTION

1. Field of the Invention

The present invention relates to an image processing apparatus that controls an SSD, a control apparatus, control methods of controlling these apparatuses, and storage medium.

2. Description of the Related Art

Conventionally, in a single function printer (SFP), a hard disk (Hard Disk Drive: HDD) has been used as a large capacity storage medium option. However, HDD evolution has been fast, and capacities, access formats, physical interfaces, and the like, have changed in a short period. Meanwhile, in a case of an SFP, a life cycle is very long compared to that of an HDD. Accordingly, components which are service parts that are mounted on an SFP need to be guaranteed over a long period.

Because the life cycle of an SFP is long, there are cases in which the supply of such components can no longer be procured, and so it is necessary to supply a large capacity storage medium for a product. Also, an interface for an option must be matched with conventional options.

In recent years there are cases in which Flash Solid State Disks (flash SSD) corresponding to a Parallel-ATA interface employed in conventional HDDs are used in place of conventional HDDs. A form of a flash SSD is a large capacity NAND flash memory. However, in the case of SSDs, when a file is deleted, only management table information is deleted, and the actual data is left on the medium. For a user having malice intent and high technical ability, it is possible to restore a deleted file, and such cases do actually occur. Recently, there are many users that value security amongst users that use SFPs, and so the necessity to avoid this kind of situation is increasing. Japanese Patent Laid-Open No. 2010-079736 proposes a method for the overwriting and deleting a portion or all of the data when it is determined that the data has a degree of confidentiality, and to delete the remaining data of a file existing on an actual medium.

However, there is a problem with the above described a conventional technique as described below. With the above described conventional technique, it is necessary to hold information for determining whether or not target data is information that is highly confidential, and it is necessary to separately maintain an arrangement or area for managing this information. However, in an apparatus such as an SFP, such an area, or the like, is limited, and it is very difficult to maintain. Meanwhile, in cases where there is the possibility that in cases where data is completely overwritten and deleted in all cases, this will lead to an increase in a system load, or a reduction in the life span of the SSD.

### SUMMARY OF THE INVENTION

The present invention enables realization of an arrangement for protecting confidentiality by deleting data completely when data of an SSD is deleted, and lengthening the life span of the SSD as much as possible.

One aspect of the present invention provides an apparatus comprising: a storage unit configured to employ a static wear leveling approach in which wear leveling occurs over an area; a first writing unit configured to write, when the storage unit is initialized, dummy data to the area of the storage unit; a second writing unit configured to release, when writing actual data to the storage unit, the dummy data written in an area of the storage unit and write the actual data in the released area; and a third writing unit configured to write, when the actual data is deleted from the storage unit, dummy data to the area in which the actual data is written.

Another aspect of the present invention provides a control apparatus connected to a storage device employing a static wear leveling approach in which wear leveling occurs over an area; a first instruction unit configured to instruct, when the storage device is initialized, a controller of the storage device to write dummy data to the area of the storage device; a second instruction unit configured to instruct, when writing actual data to the storage device, the controller of the storage device to release dummy data written in an area of the storage device and write the actual data in the released area; a third instruction unit configured to instruct, when the actual data is deleted from the storage device, the controller to delete the actual data; and a forth instruction unit configured to instruct, when a completion notification for deletion of the actual data is received from the storage device, the controller to write dummy data to an area from which the actual data is deleted.

Still another aspect of the present invention provides a method of controlling an apparatus including a storage unit employing a static wear leveling approach in which wear leveling occurs over an area, the method comprising: when the storage unit is initialized, writing dummy data to the area of the storage unit; when writing actual data to the storage unit, releasing the dummy data written in an area of the storage unit and writing the actual data in the released area; and when the actual data is deleted from the storage unit, writing dummy data to the area in which the actual data is written.

Yet still another aspect of the present invention provides a method of controlling a control apparatus connected to a storage device employing a static wear leveling approach in which wear leveling occurs over an area, the method comprising: when the storage device is initialized, instructing a controller of the storage device to write dummy data to the area of the storage device; when writing actual data to the storage device, instructing the controller of the storage device to release the dummy data written in an area of the storage device and write the actual data in the released area; when the actual data is deleted from the storage device, instructing the controller to delete the actual data; and when a completion notification for deletion of the actual data is received from the storage device, instructing the controller to write dummy data to an area from which the actual data is deleted.

Still yet another aspect of the present invention provides a non-transitory computer-readable storage medium storing a computer program for causing a computer to execute each step of the method of controlling the apparatus.

Yet still another aspect of the present invention provides a non-transitory computer-readable storage medium storing a computer program for causing a computer to execute each step of the method of controlling the control apparatus.

Further features of the present invention will be apparent from the following description of exemplary embodiments with reference to the attached drawings.

### BRIEF DESCRIPTION OF THE DRAWINGS

FIG. 1 is a view for illustrating an example configuration of an image processing apparatus (SFP) according to an embodiment.

FIG. 2 is a view for showing a 6 GB hard disk (HDD) option which is an option of the SFP.

FIG. 3 is a view for showing a flash SSD option which is an alternative to an HDD.

FIG. 4 is a view for showing a dynamic wear leveling approach.

FIG. 5 is a view for showing a static wear leveling approach.

FIG. 6 is a 32 GB flash SSD file write image view.

FIG. 7 is a view for showing a logical addresses image and a physical address image when a dummy file is not written and when a dummy file is written.

FIG. 8 is a flowchart for showing a processing procedure for flash SSD initialization in a case where a flash SSD is first inserted according to an embodiment.

FIG. 9 is a view for showing an approach for writing 32 dummy files of 1 GB after a formatting of the flash SSD in a case where the flash SSD is first inserted according to an embodiment.

FIG. 10 is a flowchart for performing a 3 GB file write to the flash SSD according to an embodiment.

FIG. 11 is an approach for writing a 3 GB file write to the flash SSD according to an embodiment.

FIG. 12 is a flowchart for deleting a 3 GB file from the flash SSD according to an embodiment.

FIG. 13 is an approach for deleting a 3 GB file from the flash SSD according to an embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Image Processing Apparatus Configuration>

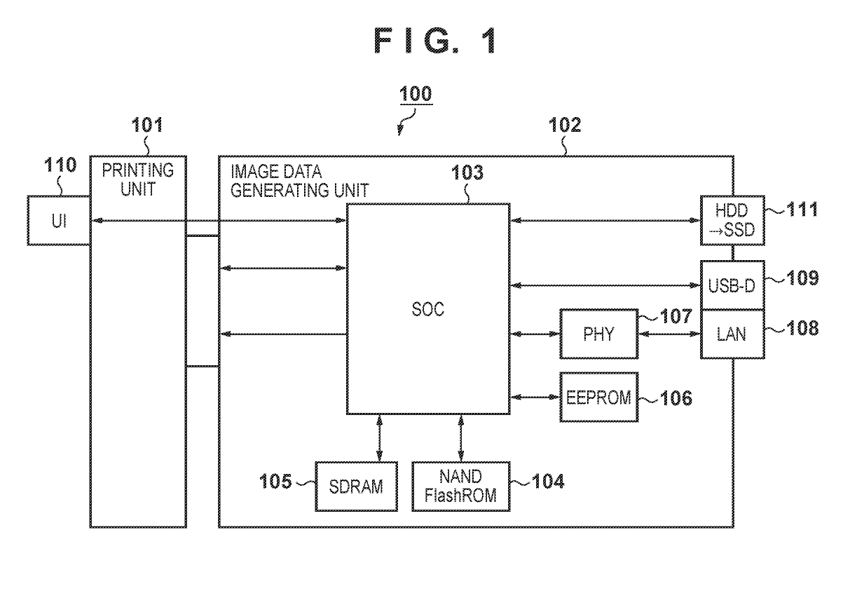

Below explanation will be given for embodiments of the present invention with reference to FIG. 1-FIG. 13. Firstly, with reference to FIG. 1, explanation will be given for an example configuration of a single function printer (SFP) which is an image processing apparatus of the present embodiment.

Numeral 100 denotes the single function printer (SFP) which is the image processing apparatus according to embodiments. Numeral 101 denotes an actual entire printing unit of the SFP 100.

Numeral 102 denotes an image data generating unit which converts data conforming to the printing unit 101 by converting print request data from a personal computer (PC), or the like, specifically into image data. Numeral 103 is an integrated circuit with a built-in CPU that performs various control on a single chip, and is referred to as a System On Chip (SOC). More specifically, the SOC 103 functions as a control apparatus, and performs control of the CPU, memory control, communication and image data transfer with the printing unit 101, and control of external interfaces such as USB, LAN, or the like, in order to receive print request data from the PC. Also, the SOC 103 is connected to a later explained flash SSD 302.

Numeral 104 denotes a NAND flash memory for storing a program code for causing the CPU built into the SOC 103 to operate, and for storing data, or the like. Numeral 105 is an SDRAM (or a DDR SDRAM), which is a memory into which program code stored in the NAND flash memory 104 is loaded, and image data is stored, and temporary data for programs is stored.

Numeral 106 denotes an EEPROM which is a non-volatile memory capable of holding information necessary for a printing apparatus even in a case where a power supply of the SFP 100 is not supplied. Numeral 107 denotes a unit referred to as a PHY and is a driver receiver IC for data communication on a network (LAN). Numeral 108 denotes a LAN (network) interface. Numeral 109 denotes a USB as is known commonly, and is referred to a USB device interface.

Numeral 110 denotes a UI by which a user causes the SFP 100 to operate. Numeral 111 is an option interface of the SFP 100, and in FIG. 1 an HDD option is inserted. A storage medium can be substituted with a flash SSD (Solid State Drive) option without changing this HDD option Parallel-ATA interface. Also, numeral 109 has a function by which it is possible to show a state of the printing apparatus on a PC via a LAN, and this is referred to as an RUI (remote UI). Printing apparatus setting is possible via the remote UI.

<HDD and SSD Configuration>

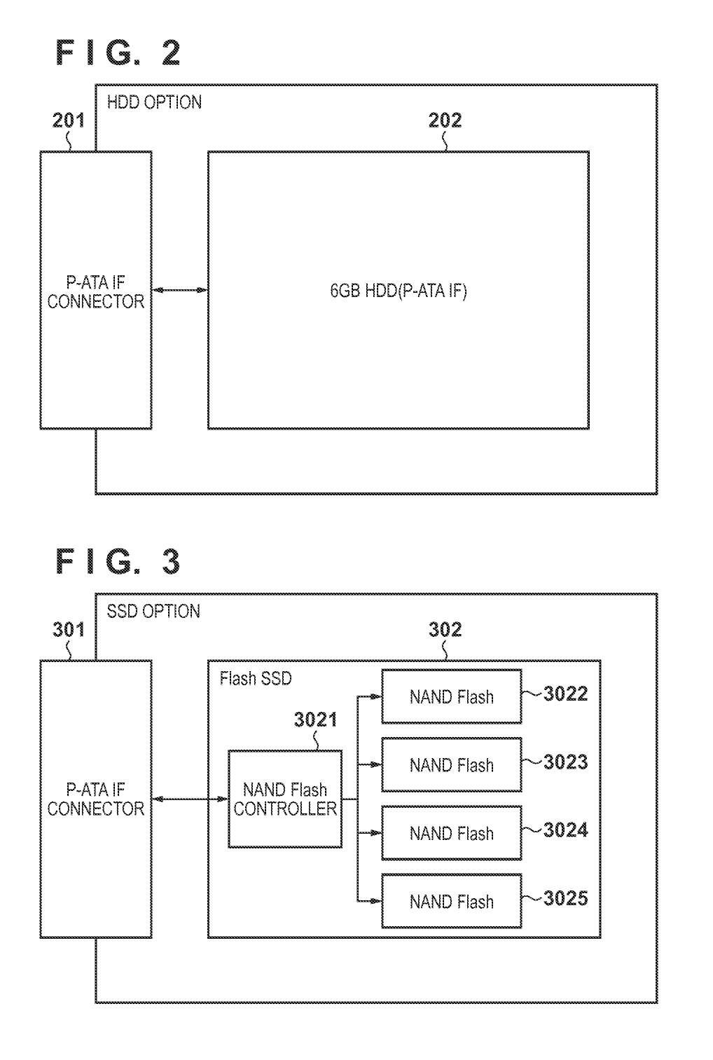

Next, with reference to FIG. 2 and FIG. 3, explanation will be given for HDD/SSD options used in the SFP 100. Numeral 201 denotes a parallel ATA IF connector. Numeral 202 denotes a 6 GB HDD (parallel ATA IF). Regarding the HDD 202, in recent years, procurement of supply has become difficult. In this embodiment, as shown in FIG. 3, in place of the HDD option a flash SSD option is used.

Numeral 301 denotes a parallel ATA IF connector and is the same as in conventional configurations. Numeral 302 denotes a flash SSD. On the flash SSD 302 a plurality of NAND flash memories 3022-3025 are mounted. A NAND flash memory controller denoted by numeral 3021 is a flash memory controller that performs wear leveling processing such that the plurality of NAND flash memories are written to evenly.

The NAND flash memories 3022-3025, when there sizes are summed, make up 32 GB. However, there is an upper limit on the number of times that it is possible to write to the NAND flash memories 3022-3025 which are storage devices mounted on the flash SSD 302 (Single Level Cell: SLC, Multi-Level Cell: MLC). The upper limit of the SLC is approximately one hundred thousand times, and the upper limit of the MLC is approximately ten thousand times. Furthermore, due to process miniaturization, the number of times for which flash memories will be rewritable will have a tendency to decrease in the future from what is rewritable currently.

In response to this, the flash memory controller 3021 mounted in the flash SSD 302 handles the problem of the number of times flash memory is rewritten by using a technique called wear leveling for lengthening the life span of storage devices by averaging write destinations so that write frequency to the same area is not concentrated. In wear leveling there are mainly two types of approaches known as dynamic wear leveling and static wear leveling. In the present invention, static wear leveling is employed, and in a flash SSD not having a full delete command, for the sake of security control is performed so as to prevent data being actually left even though the intention is that a file be deleted, and not leave data.

<Wear Leveling>

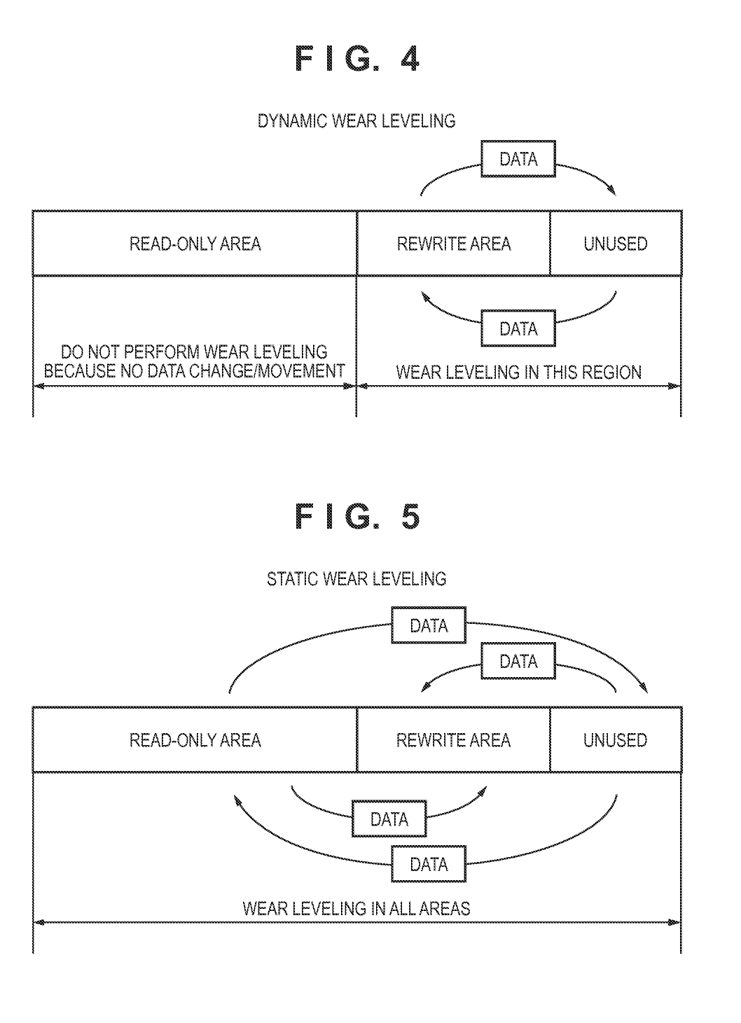

With reference to FIG. 4 and FIG. 5, explanation will be given for the dynamic wear leveling and the static wear leveling. Dynamic wear leveling, as illustrated in FIG. 4, has a characteristic in that wear leveling is executed in a region of physical memory allocated for a write address. In other words, static data that is not frequently updated such as an operating system (OS) is left unchanged, and only dynamic data (new data) is distributed. For this reason, while on one side this has the pro that the number of times rewriting is performed can be suppressed since only necessary rewriting is performed on the physical memory, this also has the con that there will be the possibility that the valid range of the wear leveling becomes narrower depending on a use situation of the physical memory.

<Changing to SSD>

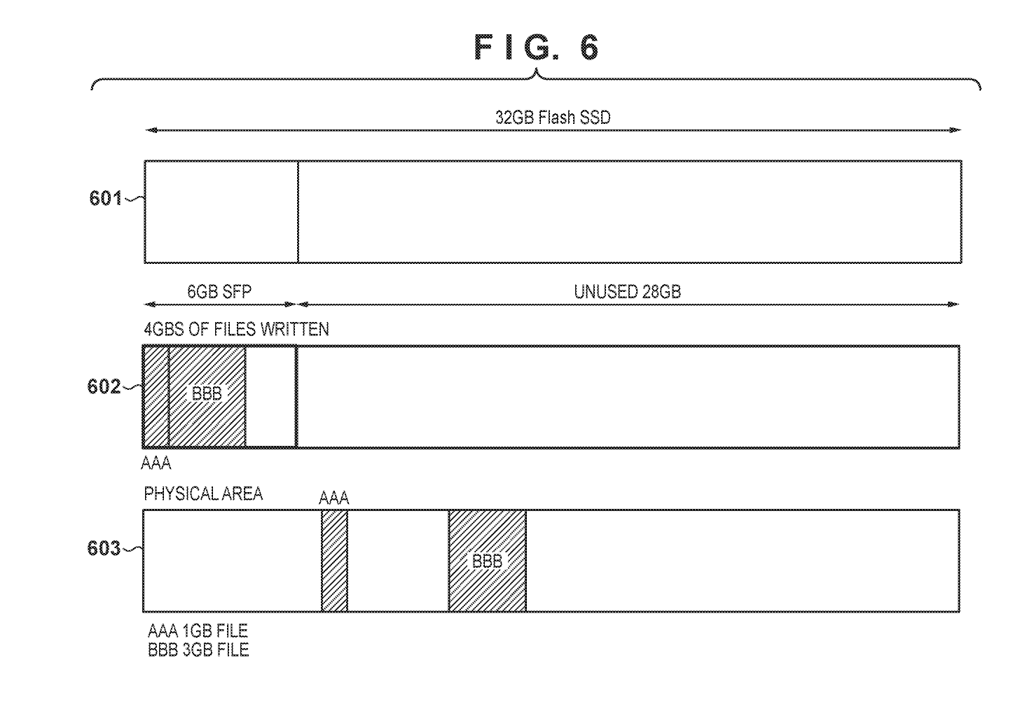

Next, with reference to FIG. 6, explanation will be given for a case in which an HDD option used in the SFP 100 is changed to a flash SSD. Originally, an HDD option used in the SFP 100 does not require a large capacity and so the capacity of the HDD at the time of design is around 6 GB. Also, even though the capacity of the HDD is increased, and the capacity of the HDD having the same Parallel ATA interface type is increased to 10 GB, 20 GB, 40 GB, or 60 GB, the capacity actually used remains unchanged at 6 GB.

However, the HDD having the parallel ATA interface stops being produced, and so it is necessary to change to a parallel ATA interface flash SSD. However, in flash SSDs there are flash memory controllers which do not have a full delete command function. In a case where a static wear leveling approach flash memory controller is employed and the flash SSD does not have a full delete command function, data is left even though the intention is that the data be deleted.

As shown in numeral 601, the capacity of the flash SSD is 32 GB, but actually only 6 GB is used. As illustrated in numeral 602, even if a 1 GB file named AAA and a 3 GB file named BBB are written, because the static wear leveling approach is used, as illustrated in numeral 603, it cannot be recognized where in the 32 GB physical area has been written. Accordingly, in a case where the flash SSD does not have a full delete command, there will be the possibility that data will be left as long as the entire area is not deleted.

<Dummy File>

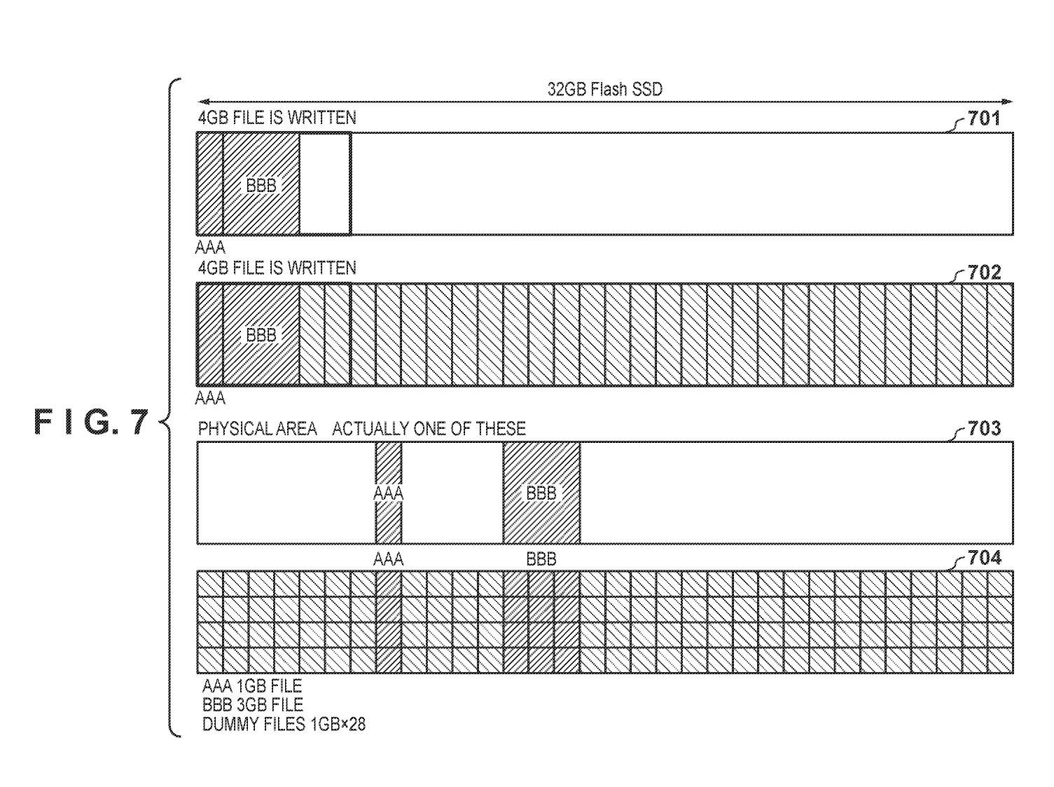

Next, with reference to FIG. 7, explanation will be given for writing of a dummy file applied in the present embodiment in order to solve the above described problem. Assuming that the two files written are a total of 4 GB (the AAA file is 1 GB and the BBB file is 3 GB), twenty eight dummy files having units of 1 GB, for example, are written in the remaining 28 GB. In other words, the size of one dummy file is 1 GB. It is assumed that the dummy files cannot be checked by a user using the SFP 100 as a normal file can be, and that the dummy files are managed by a program of the SFP 100. Also, the dummy file may be a collection of FFh data. With this, it is possible to configure such that it is not necessary to re-initialize the area that is used.

Numeral 701 denotes a logical address image flash SSD onto which the 1 GB AAA file and the 3 GB BBB file are written, prior to the present invention being applied. In numeral 701, a total of 4 GB of actual data is written. Numeral 702 denotes a logical address image flash SSD into which the 1 GB AAA file and the 3 GB BBB file are written and twenty eight 1 GB dummy files are written in a case where the present invention is applied. Accordingly, in numeral 702, a total of 32 GB of data is written (4 GB of actual data and 28 GB of artificial data (dummy data)).

Numeral 703 denotes a physical address image flash SSD onto which the 1 GB AAA file and the 3 GB BBB file are written, prior to the present invention being applied. Meanwhile, numeral 704 denotes a physical address image flash SSD into which the 1 GB AAA file and the 3 GB BBB file are written and twenty eight 1 GB dummy files are written in a case where the present invention is applied.

Here, it is assumed that the unit of writing is 1 GB, and actual blocks are controlled by the flash SSD controller in 256 MB units, and static wear leveling is performed in 256 MB units. However, this control may be performed by the NAND flash memory controller 3021 of FIG. 3 without performing control of software of the SFP 100.

The SFP 100 manages, in a management table, the file called AAA which is 1 GB and that the user can recognize, and the file called BBB which is 3 GB and that the user can recognize, and also the twenty eight 1 GB unit dummy files managed by software of the SFP 100 but which the user cannot recognize.

<Initialization Procedure>

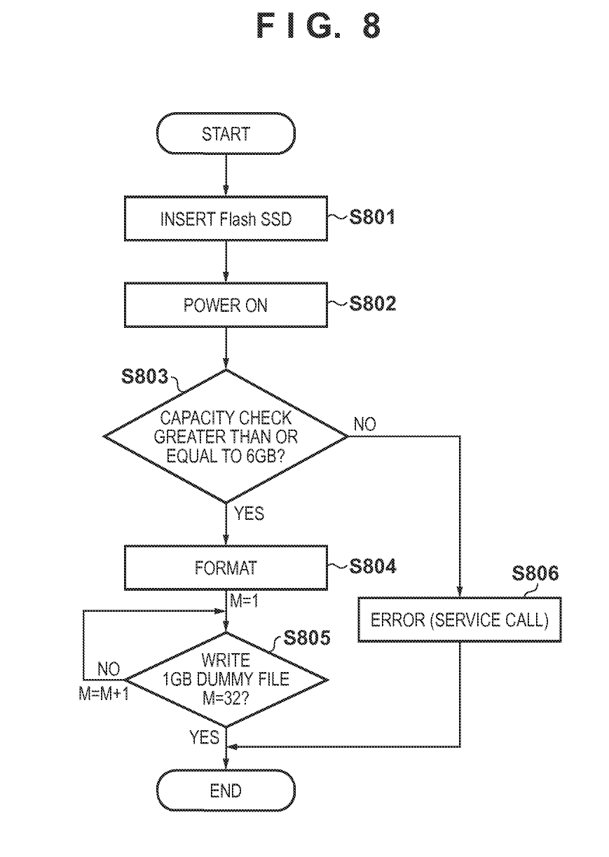

Next, with reference to FIG. 8, explanation will be given for a processing procedure of the SFP 100 when a flash SSD is first inserted, and a power supply is activated. The processing explained below is realized by the CPU included in the SOC 103 executing a control program stored in a memory, or the like. In step S801, the flash SSD, in FIG. 1, is inserted into the option interface 111 into which the HDD option has been inserted, and the power supply is activated in step S802.

In step S803, the SOC 103 checks the capacity of the flash SSD which is an inserted option of the SFP 100, and determines whether or not there is greater than or equal to the 6 GB of the original HDD option. In a case where there is greater than or equal to 6 GB, the processing proceeds to step S804, and in a case where there is less than 6 GB, the processing proceeds to step S806. In step S806, the SOC 103 performs error processing, displays to a display unit (UI) of the SFP 100 a service call that indicates the error, and the process is terminated.

Meanwhile, in step S804, the SOC 103 formats the SSD. Here, the capacity is 32 GB. Continuing on, in step S805, the SOC 103 determines whether or not writing of thirty two 1 GB dummy files has completed. The determination of step S805 is performed repeatedly, starting at M=1, and repeating for each dummy file write increasing M by 1 until M becomes 32. If M=32, it is determined that writing of thirty two dummy files has completed, and the initialization ends.

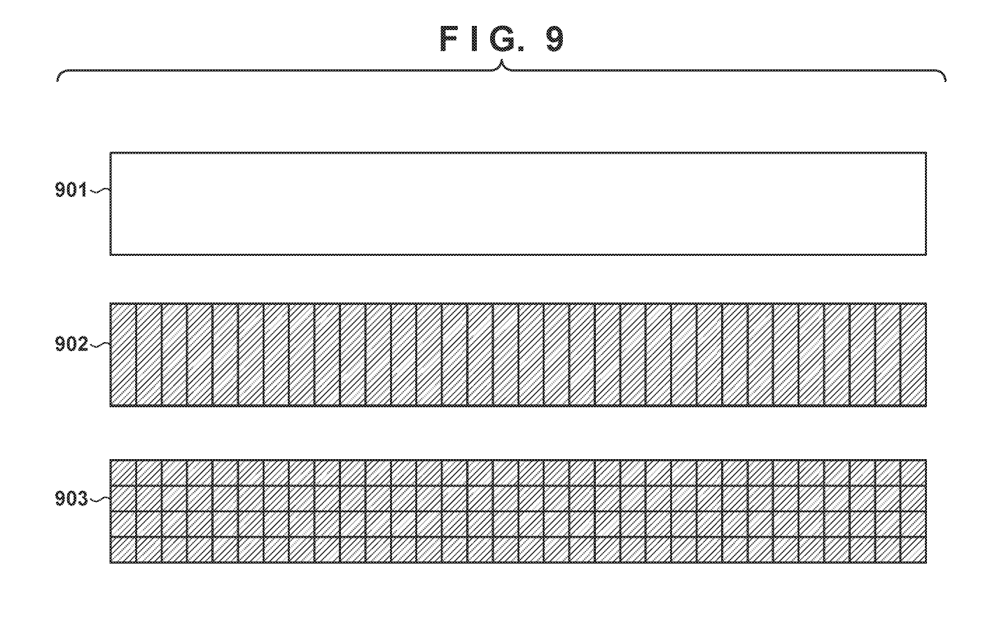

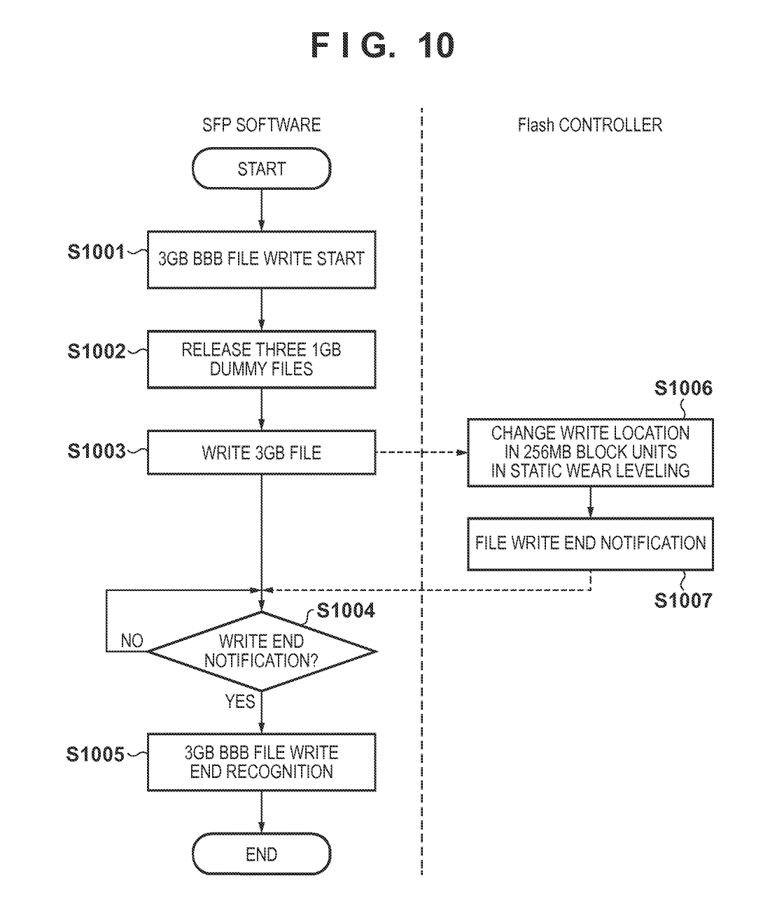

FIG. 9 shows a state of the flash SSD, and represents a state in which numeral 901 is formatted in step S803. Numeral 902 denotes a state in which initialization of the flash SSD of the present invention has completed, and represents a state in which after being formatted, thirty two 1 GB dummy files, which the user cannot recognize and which are managed by software of the SFP 100, are written. Furthermore, numeral 903 denotes how these 1 GB files are actually controlled in blocks in 256 MB units.

<Actual Data Write Processing>

Next, with reference to FIG. 10, explanation will be given for a processing procedure for when a 3 GB file (actual data) is written. The processing explained below is realized by the CPU included in the SOC 103 executing a control program stored in a memory, or the like.

In step S1001, writing of the 3 GB BBB file is started. In step S1002, the SOC 103 releases a 3 GB area (three 1 GB dummy files together) from the state of numeral 903 of FIG. 9. Continuing on, in step S1003, the SOC 103 writes the 3 GB BBB file into the released area. Here, the flash memory controller 3021 writes the 3 GB BBB file while performing static wear leveling when, in step S1006, the 3 GB BBB file is written. Furthermore, in step S1007, the flash memory controller 3021 notifies (completion notification) the SOC 103 of the write end when the write ends. In the meantime, the SOC 103, in step S1004, waits until the SOC 103 receives a write processing end notification from the flash memory controller 3021, and when the notification is received, recognizes the write end of step S1005, and completes the processing.

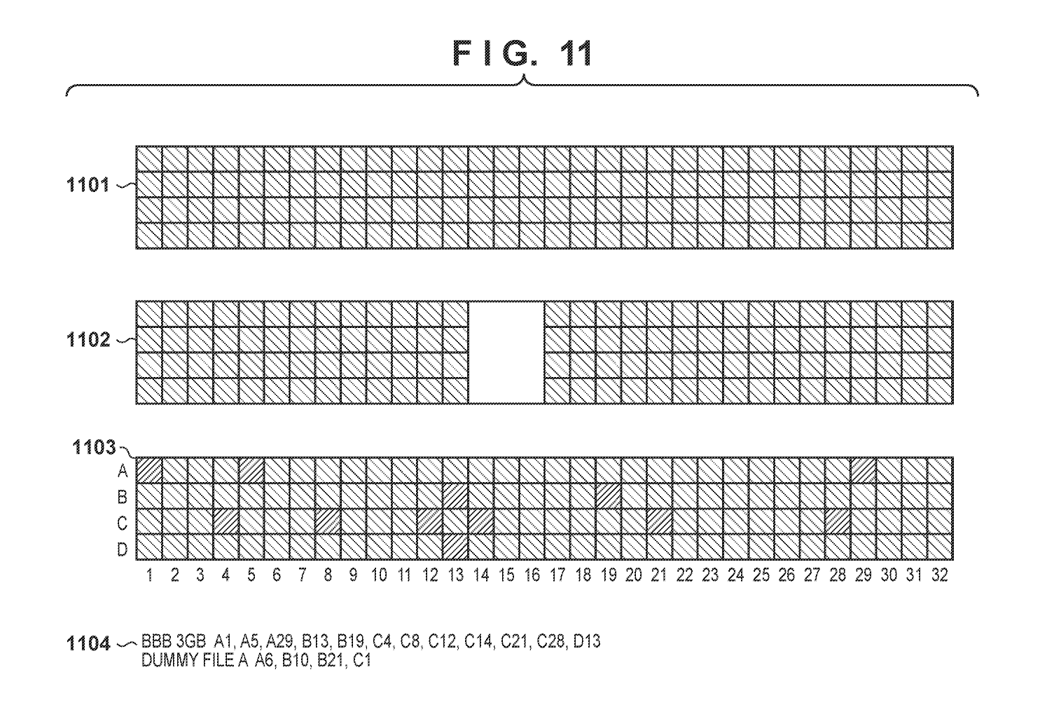

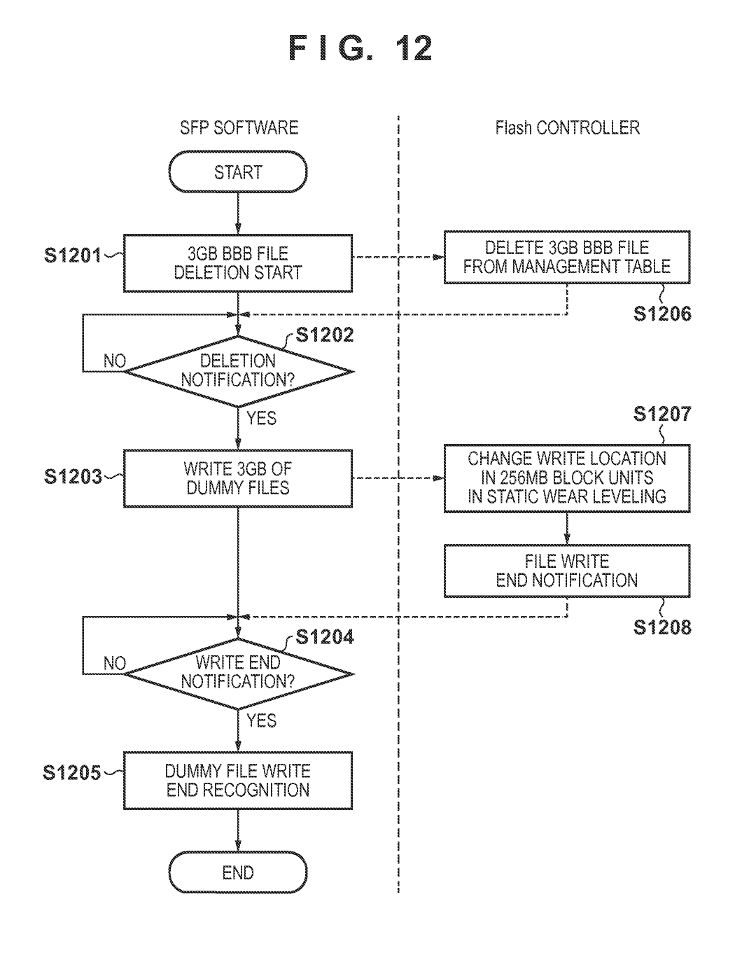

FIG. 11 represents states of a memory area when the write processing of FIG. 10 is executed. Numeral 1101 denotes an initialization state in which the thirty two dummy files are written upon power supply activation, and represents a state in which the flash memory controller 3021 controls in 256 MB units. Numeral 1102 denotes a state in which the three 1 GB dummy files are released. Numeral 1103 denotes a state in which the file is written to the released 3 GB area, and here static wear leveling occurs, and the data is moved in 256 MB unit blocks.

Numeral 1104 denotes physical addresses, that the flash memory controller 3021 manages, that manage which areas are used for the 3 GB of BBB in a logical address table. Note, this management table cannot be recognized by the SOC 103 and is managed within the flash memory controller 3021. Note, the remaining twenty nine 1 GB dummy files are actually managed by the flash memory controller 3021 in the same way.

<Actual Data Deletion Processing>

Next, with reference to FIG. 12, explanation will be given for a processing procedure for when the 3 GB file (actual data) is deleted. The processing explained below is realized by the CPU included in the SOC 103 executing a control program stored in a memory, or the like.

In step S1201, deletion of the 3 GB BBB file is started. Here, in step S1206, the flash memory controller 3021 deletes the 3 GB BBB file from the management table. When the deletion ends, the flash memory controller 3021 transmits a deletion notification representing a completion of the data deletion to the SOC 103.

In step S1202, the SOC 103 receives the deletion notification. Here, actually, the state is such that the data itself is left in the flash SSD 302, and the data is only deleted from the management tables of the SOC 103 and the flash memory controller 3021. Continuing on, in step S1203, the SOC 103 writes three 1 GB dummy files. In step S1207, the flash memory controller 3021 writes three 1 GB the dummy file in 256 MB units in static wear leveling.

When the file write ends, the flash memory controller 3021, in step S1208, transmits a write end notification to the SOC 103. In step S1205, the SOC 103 completes the processing when the SOC 103 receives the write end notification.

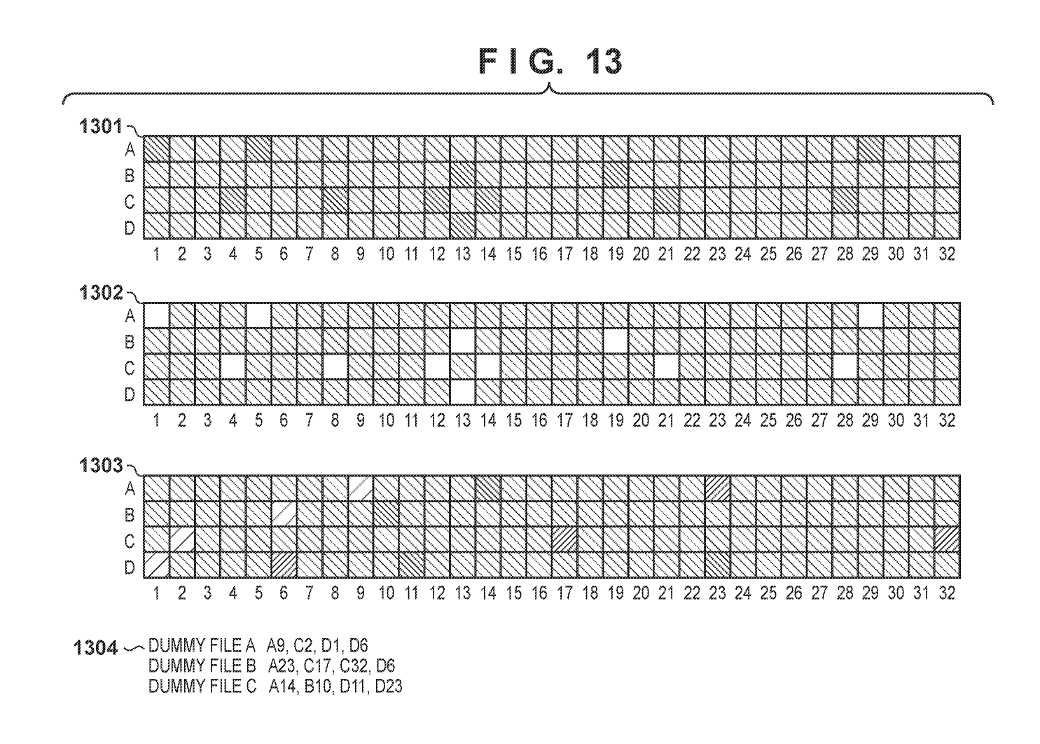

FIG. 13 represents states in which the 3 GB file is deleted, and the three dummy files are written. Numeral 1301 denotes the 3 GB file (the BBB file). Here, a state is that when the 3 GB file BBB of numeral 1103 of FIG. 11 is written. Numeral 1302 denotes the state in which the 3 GB file is deleted (released). In this state, as explained in step S1206, the file ceases to exist in the management table of the flash memory controller 3021 and in the management table of the SOC 103.

Numeral 1303 denotes the state in which the three 1 GB dummy files are written. More specifically, static wear leveling occurs in 256 MB units, and furthermore, the physical addresses at which the data actually exists are changed. Numeral 1304 denotes information managed in the SOC 103 as 1 GB dummy files even though the newly written dummy files are controlled by the flash memory controller 3021 at separate physical addresses.

In this way, by always writing dummy files, it is possible to configure so that remaining data is not left on the flash SSD 302 when the data is deleted. Also, by virtue of the present embodiment, in an initialization state, in the physical addresses, dummy files exist over all areas, and dummy files are written even in a case where actual data is deleted after having been written. Accordingly, because a file is always written for the entire area, even if the SSD does not have a full delete command, it is possible to control so that remaining data is not left ever.

As explained above, the image processing apparatus according to embodiments is provided with a flash SSD that employs a static wear leveling approach in which wear leveling occurs over an entire area. Also, the image processing apparatus, when the flash SSD is initialized, writes a plurality dummy files of a predetermined size to the entire area of the flash SSD, and when actual data is written to the flash SSD, releases at least one of the plurality dummy files written in the area of the flash SSD, and writes the actual data in the released area. Furthermore, the image processing apparatus writes dummy files to an area in which actual data is written when the actual data is deleted from the flash SSD. With this, the image processing apparatus according to the embodiment is able to protect confidentiality by deleting data completely when data of the SSD is deleted, and to lengthen the life span of the SSD as much as possible. Also, according to the present embodiment, explanation was given for an example in which the SOC 103, which is a control apparatus, performs the above described control instructions, and the actual write processing of writing to the flash SSD is performed by the flash memory controller 3021 which controls the flash SSD 302. However, the present invention is not limited to such a form divided between the SOC 103 and the flash memory controller 3021, and a similar configuration may be taken if of a form in which the above described control is performed.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-200521 filed on Sep. 26, 2013, which is hereby incorporated by reference herein in its entirety.

What is claimed is:

1. An apparatus comprising:
a storage unit configured to employ a static wear leveling approach in which wear leveling occurs over an area;
a first writing unit configured to write, when the storage unit is initialized, dummy data to the area of the storage unit;
a second writing unit configured to release, when writing actual data to the storage unit, the dummy data written in an area of the storage unit and write the actual data in the released area; and
a third writing unit configured to write, when the actual data is deleted from the storage unit, dummy data to the area in which the actual data is written.

2. The apparatus according to claim 1, further comprising a management table for managing the area in which the actual data is written.

3. The apparatus according to claim 2, wherein when the actual data is deleted, the dummy data is written to the area in which the actual data is written in accordance with information of the management table.

4. The apparatus according to claim 1, wherein the writing of the dummy data is performed by writing FFh data.

5. The apparatus according to claim 1, wherein the storage unit is a flash SSD.

6. A control apparatus connected to a storage device employing a static wear leveling approach in which wear leveling occurs over an area, comprising;
a first instruction unit configured to instruct, when the storage device is initialized, a controller of the storage device to write dummy data to the area of the storage device;
a second instruction unit configured to instruct, when writing actual data to the storage device, the controller of the storage device to release dummy data written in an area of the storage device and write the actual data in the released area;
a third instruction unit configured to instruct, when the actual data is deleted from the storage device, the controller to delete the actual data; and
a forth instruction unit configured to instruct, when a completion notification for deletion of the actual data is received from the storage device, the controller to write dummy data to an area from which the actual data is deleted.

7. The control apparatus according to claim 6, wherein the controller
comprises a management table for managing the area in which the actual data is written.

8. The control apparatus according to claim 6, wherein the controller
deletes information of the management table when the controller receives the instruction to delete the actual data, and
writes the dummy data to the area in which the actual data is written when the controller receives the instruction to write the dummy data to the area from which the actual data is deleted.

9. The control apparatus according to claim 6, wherein the writing of the dummy data is performed by writing FFh data.

10. The control apparatus according to claim 6, wherein the storage device is a flash SSD.

11. A method of controlling an apparatus including a storage unit employing a static wear leveling approach in which wear leveling occurs over an area, the method comprising:
when the storage unit is initialized, writing dummy data to the area of the storage unit;
when writing actual data to the storage unit, releasing the dummy data written in an area of the storage unit and writing the actual data in the released area; and
when the actual data is deleted from the storage unit, writing dummy data to the area in which the actual data is written.

12. A method of controlling a control apparatus connected to a storage device employing a static wear leveling approach in which wear leveling occurs over an area, the method comprising:
when the storage device is initialized, instructing a controller of the storage device to write dummy data to the area of the storage device;
when writing actual data to the storage device, instructing the controller of the storage device to release the dummy data written in an area of the storage device and write the actual data in the released area;
when the actual data is deleted from the storage device, instructing the controller to delete the actual data; and
when a completion notification for deletion of the actual data is received from the storage device, instructing the controller to write dummy data to an area from which the actual data is deleted.

13. A non-transitory computer-readable storage medium storing a computer program for causing a computer to execute each step of the method of controlling the apparatus according to claim 11.

14. A non-transitory computer-readable storage medium storing a computer program for causing a computer to execute each step of the method of controlling the control apparatus according to claim 12.
